(19) United States
(12) Patent Application Publication
(10) Pub. No.: US 2021/0347371 A1
(43) Pub. Date: Nov. 11, 2021

(54) METHOD AND APPARATUS FOR CONTROLLING AUTONOMOUS DRIVING

(71) Applicants: HYUNDAI MOTOR COMPANY, Seoul (KR); KIA MOTORS CORPORATION, Seoul (KR)

(72) Inventors: Dong Hwi LEE, Seongnam-si (KR); Kyoung Jun LEE, Seoul (KR); Chang Young JUNG, Seoul (KR); Hoi Won KIM, Seoul (KR); Dong Gu LEE, Seoul (KR)

(73) Assignees: HYUNDAI MOTOR COMPANY, Seoul (KR); KIA MOTORS CORPORATION, Seoul (KR)

(21) Appl. No.: 17/038,243

(22) Filed: Sep. 30, 2020

(30) Foreign Application Priority Data
May 11, 2020 (KR) 10-2020-0056000

(51) Int. Cl. B60W 50/029; B60W 60/00; B60W 50/02; B60W 30/09

(52) U.S. Cl. CPC B60W 50/029; B60W 60/00186; B60W 2050/0292; B60W 60/0053; B60W 30/09; B60W 50/0225

(57) ABSTRACT

A method for controlling autonomous driving of an autonomous driving vehicle including a first autonomous driving controller and an second autonomous driving controller which are provided in a dual structure, includes: monitoring a system fault using the first autonomous driving controller during the second driving; switching over to the second autonomous driving controller when the system fault is detected; and entering a Minimum Risk Management (MRM) mode to control deceleration of the autonomous driving vehicle. When the fault of the autonomous driving vehicle occurs, a risk is minimized.

### CROSS-REFERENCE TO RELATED APPLICATION

This application claims priority to and the benefit of Korean Patent Application No. 10-2020-0056000, filed on May 11, 2020, the entire contents of which are incorporated herein by reference.

### FIELD

The present disclosure relates to controlling an autonomous driving vehicle, and more particularly to a method for controlling autonomous driving, capable of providing a strategy (Minimum Risk Management; MRM) of minimizing a risk when there occurs a situation in which an autonomous driving function cannot be normally performed anymore.

### BACKGROUND

The statements in this section merely provide background information related to the present disclosure and may not constitute prior art.

An autonomous driving vehicle requires an ability to adaptively cope with a surrounding situation changing in real time during driving.

To mass-produce and activate the autonomous driving vehicle, a reliable Fail/Safe function is required above all.

In other words, it is matter of a manner that the autonomous driving vehicle copes with the situation that it is failed or not normally operated.

Autonomous driving systems in Level 2 currently in production may provide significantly simple Fail/Safe functions.

For example, in Highway Driving Assist, which has been recently introduced, when a line is not recognized for a specific time or more while the autonomous driving function is being performed, a vehicle notifies a driver of a system fault through visual or audible information and automatically releases an autonomous driving system.

In other words, the vehicle transfers a control authority (take over) to a driver such that the driver totally copes with the following situation.

However, we have discovered that when the autonomous driving system is automatically turned off, the driver may not clearly recognize the system fault.

Currently, the policy of each country recommends manufacturers to add MRM for mass-production of autonomous driving vehicles.

Accordingly, there is required a manner of minimizing a risk when the autonomous driving vehicle fails to perform a normal autonomous driving function due to the fault of an autonomous driving controller or a communication fault.

### SUMMARY

The present disclosure has been made to solve the above-mentioned problems occurring in the prior art while advantages achieved by the prior art are maintained intact.

An aspect of the present disclosure provides a method and an apparatus for controlling autonomous driving.

Another aspect of the present disclosure provides a method for controlling autonomous driving, capable of providing MRM in a dangerous situation during the autonomous driving, and an apparatus for the same.

Another aspect of the present disclosure provides a method for controlling autonomous driving, capable of minimizing a risk resulting from the fault of an autonomous driving system through dual autonomous driving controllers, and an apparatus for the same.

Another aspect of the present disclosure provides a method for controlling autonomous driving, capable of performing MRM by automatically transferring a control authority over a system to an s autonomous driving controller in the fault of a first autonomous driving controller, and an apparatus for the same.

The technical problems to be solved by the present disclosure are not limited to the aforementioned problems, and any other technical problems not mentioned herein will be clearly understood from the following description by those skilled in the art to which the present disclosure pertains.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a method for controlling autonomous driving of an autonomous driving vehicle including a first autonomous driving controller and an second autonomous driving controller which are provided in a dual structure may include monitoring a system fault using the first autonomous driving controller during the autonomous driving, switching over to the second autonomous driving controller when sensing the system fault, and then entering a Minimum Risk Management (MRM) mode to control deceleration of the autonomous driving vehicle using the second autonomous driving controller.

According to one form, the system fault may include at least one of a fault of a controller of the autonomous driving vehicle or a communication fault.

According to another form, the second autonomous driving controller partially may include a function of the first autonomous driving controller.

According to some forms, the fault of the controller may be a fault of the first autonomous driving controller, and a control authority over the autonomous driving may be transferred to the second autonomous driving controller, when the fault of the first autonomous driving controller occurs.

According to some forms, the first autonomous driving controller may include a precision positioning equipment, a cognition equipment, a determination equipment, and a control equipment, based on sensing information, and the second autonomous driving controller may include the cognition equipment to recognize a line and a vehicle driving in front, based on the sensing information from a front camera and a front radar, and the control equipment to control the deceleration by calculating a required command value based on the recognition result.

According to some forms, the method may further include outputting a predetermined warning alarm message for a request for transferring a control authority from a system to the driver, when the system fault is detected, and the outputting of the warning alarm message may be stopped and the autonomous driving is released, when the control authority is completely transferred.

According to some forms, the controlling of the deceleration may be performed in a state that a lane is maintained, until the autonomous driving vehicle is stopped, and a control authority may be automatically transferred from a system to a driver of the autonomous driving vehicle such that the autonomous driving is released, when sensing a lateral control during the controlling of the deceleration.

According to some forms, a deceleration degree may be adaptively controlled in the state that the lane is maintained, to prevent collision with a front vehicle.

According to some forms, the autonomous driving vehicle may include a steering controller to adjust a driving direction, an acceleration/deceleration controller to adjust a driving speed, a first communication line to connect the first autonomous driving controller, the steering controller, and the acceleration/deceleration controller together, and a second communication line to connect the second autonomous driving controller, the steering controller, and the acceleration/deceleration controller together, and the first communication line is automatically switched over to the second communication line for use when the communication fault is sensed while the first communication line is used.

According to some forms, the steering controller and the acceleration/deceleration controller may transmit a predetermined fault sensing signal to the second autonomous driving controller to activate the second autonomous driving controller, when sensing the system fault.

According to another aspect of the present disclosure, an apparatus for controlling autonomous driving, may include: a sensor mounted on an inner portion or an outer portion of an autonomous driving vehicle to generate sensing information, a first controller including a first autonomous driving controller and an second autonomous driving controller, which are provided in a dual structure, to control autonomous driving based on the sensing information received from the sensor, and a second controller to sense a system fault during the autonomous driving by using the first autonomous driving controller. The first controller may switch over to the second autonomous driving controller when sensing the system fault, and enter a Minimum Risk Management (MRM) mode to control deceleration of the autonomous driving vehicle.

According to some forms, the system fault may include at least one of a fault of a controller of the autonomous driving vehicle or a communication fault.

According to some forms, the second autonomous driving controller may partially perform a function of the first autonomous driving controller.

According to some forms, the fault of the controller may be a fault of the first autonomous driving controller, and the second controller may perform a control operation to switch over a control authority over the autonomous driving to the second autonomous driving controller when the fault of the first autonomous driving controller occurs.

According to some forms, the first autonomous driving controller may include a precision positioning device to generate information on a present position of the autonomous driving vehicle, based on the sensing information, a first cognition device to generate information on a line and information on a vehicle driving in front, based on the sensing information, a determination device to determine whether a dangerous situation occurs, based on the generated information, a first controller to control steering and a speed by calculating a required command value depending on the generated information and the determination result. The sensor may include a front camera and a front radar, and the second autonomous driving controller may include a second cognition device to generate the information on the line and the information on the vehicle driving in front, based on the sensing information received from the front camera and the front radar, and a second controller to perform the controlling of the deceleration by calculating the required command value based on the information on the line and the information on the vehicle driving in front.

According to some forms, the apparatus may include a warning alarm device to output a predetermined warning alarm message for a request for transferring a control authority from a system to the driver, and the outputting of the warning alarm message may be stopped and the autonomous driving is released, when the control is completely transferred.

According to some forms, the first controller may perform the controlling of the deceleration in a state that a lane is maintained, until the autonomous driving vehicle is stopped, and automatically transfers a control authority from a system to a driver such that the autonomous driving is released, when sensing a lateral control during the controlling of the deceleration.

According to some forms, the first controller may adaptively control a deceleration degree in the state the lane is maintained, to prevent collision with a front vehicle.

According to some forms, the second controller may include a steering controller to adjust a driving direction of the autonomous driving vehicle, and an acceleration/deceleration controller to adjust a driving speed of the autonomous driving vehicle. The autonomous driving vehicle may include a first communication line to connect the first autonomous driving controller, the steering controller, and the acceleration/deceleration controller together, a second communication line to connect the second autonomous driving controller, the steering controller, and the acceleration/deceleration controller together, and

According to some forms, the first communication line may be automatically switched over to the second communication line for use when the communication fault is sensed while the first communication line is used.

According to some forms, the steering controller and the acceleration/deceleration controller may transmit a predetermined fault sensing signal to the second autonomous driving controller to activate the second autonomous driving controller.

The technical problems to be solved by the present disclosure are not limited to the aforementioned problems, and any other technical problems not mentioned herein will be clearly understood from the following description by those skilled in the art to which the present disclosure pertains.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a table having defined autonomous levels of an autonomous driving vehicle in one form of the present disclosure;

FIG. 2 is a block diagram illustrating a structure of an apparatus for controlling autonomous driving in one form of the present disclosure;

FIG. 3 is a view illustrating a procedure of controlling autonomous driving as a system fault occurs, according to an exemplary form of the present disclosure; and

FIG. 4 is a flowchart illustrating a method for controlling autonomous driving in an apparatus for controlling autonomous driving in another form of the present disclosure.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

Hereinafter, some forms of the present disclosure will be described in detail with reference to accompanying drawings. In adding the reference numerals to the components of each drawing, it should be noted that the identical or equivalent component is designated by the identical numeral even when they are displayed on other drawings. In addition, in the following description of some exemplary forms of the present disclosure, a detailed description of well-known features or functions will be ruled out in order not to unnecessarily obscure the gist of the present disclosure.

In describing the components of the forms according to the present disclosure, terms such as first, second, “A”, “B”, (a), (b), and the like may be used. These terms are merely intended to distinguish one component from another component, and the terms do not limit the nature, sequence or order of the constituent components. In addition, unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application

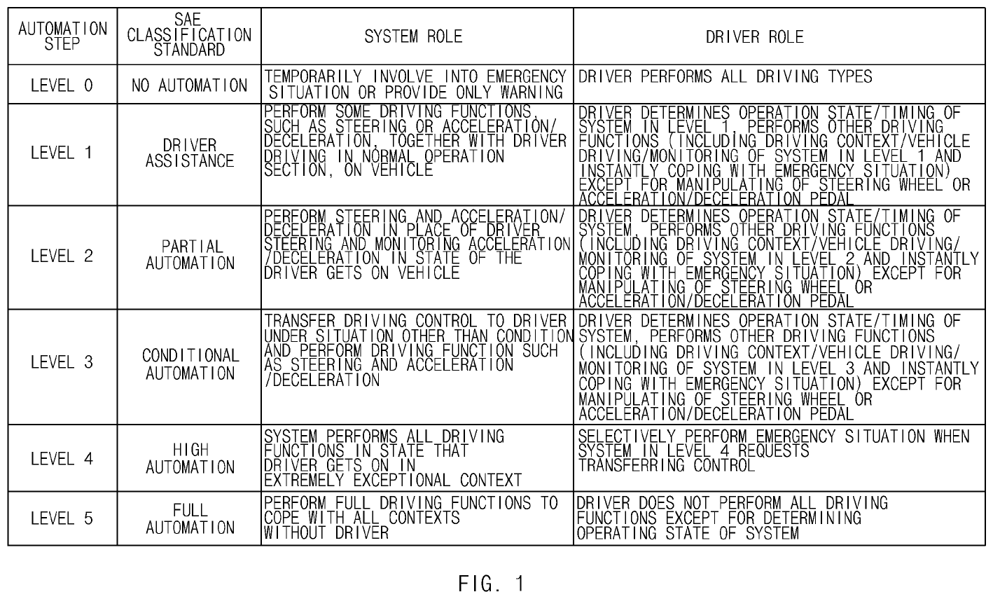

Hereinafter, some exemplary forms of the present disclosure will be described with reference to FIGS. 1 to 4.

FIG. 1 is a table having defined autonomous levels of an autonomous driving vehicle, according to one form of the present disclosure.

The autonomous driving vehicle refers to a self-driving vehicle to recognize a driving environment for itself to determine dangerousness, and controlling a driving route while minimizing the driving operation by the driver.

Finally, the autonomous driving vehicle refers to a vehicle that is able to perform driving, controlling, and parking without the influence by a person. The autonomous driving vehicle are focused on a vehicle advanced in an autonomous driving technology, which is the core of the autonomous driving vehicle and indicates an ability to operate the vehicle without the active control or monitoring of the driver.

However, the present concept of the autonomous driving vehicle may include an automation level (autonomous driving level) in the intermediate level, as illustrated in FIG. 1, aiming at full automation vehicle, and may correspond to a target-oriented concept for mass-production and commercialization of a full autonomous vehicle.

According to one form of the present disclosure, a method for controlling autonomous driving is applicable to the autonomous driving vehicle corresponding to level 3 (conditional automation) among automation levels illustrated in FIG. 1, but is not limited thereto. For example, the method for controlling the autonomous driving is applicable to an autonomous driving vehicle in all levels having a situation of transferring a control authority.

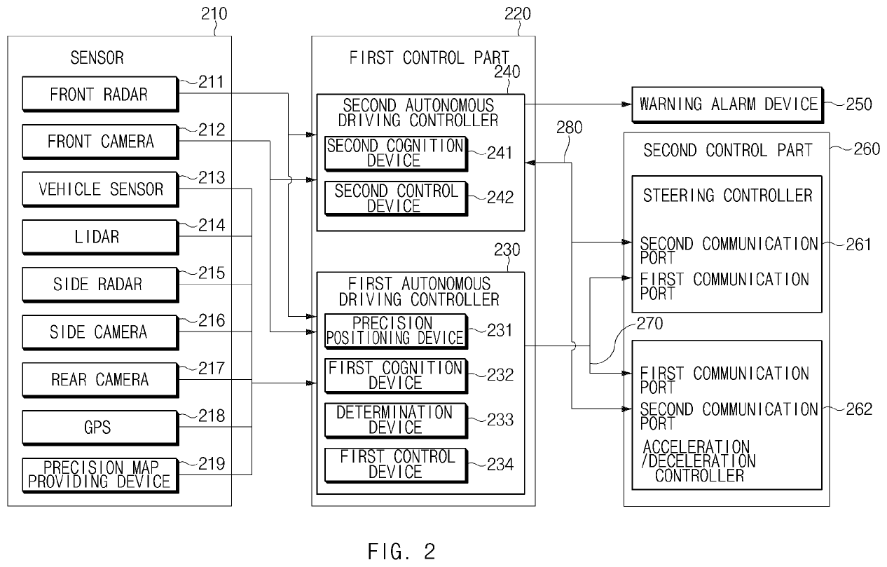

The automation levels of the autonomous driving vehicle based on the American Society of Automotive Engineers (SAE) may be classified as in the table of FIG. 2.

FIG. 2 is a block diagram illustrating the structure of an apparatus for controlling autonomous driving, according to one form of the present disclosure.

Referring to FIG. 2, an apparatus 200 for controlling autonomous driving may be configured to mainly include a sensor 210, a first controller 220, a second controller 260, and a warning alarm device 250.

The sensor 210 includes a front radar 211, a front camera 212, various vehicle sensors 213, a LiDAR 214, a side radar 215, a side camera 216, a rear camera 217, a global positioning system (GPS) 218 and a precision map providing device 219.

The first controller 220 may be configured to include a first autonomous driving controller 230 and a second autonomous driving controller 240 which are provided in a dual structure. The first autonomous driving controller 230 includes a main autonomous driving controller, the second autonomous driving controller 240 includes an auxiliary autonomous driving controller.

When a system fault occurs while autonomous driving is performed through the first autonomous driving controller 230, the control authority over the autonomous driving may be automatically switched over from the first autonomous driving controller 230 to the second autonomous driving controller 240 to maintain the autonomous driving.

When an autonomous driving controller is automatically switched over, the autonomous driving vehicle enters an MRM mode to perform deceleration.

According to one form, the second autonomous driving controller 240 may be configured to partially perform a function of the first autonomous driving controller 230.

For example, the first autonomous driving controller 230 may be configured to include a precision positioning device 231 to generate information on a present position of the autonomous driving vehicle, based on the sensing information collected from the sensor 210, a first cognition device 232 to generate information on a line and information on a vehicle driving in front, based on the sensing information, a determination device 233 to determine whether a dangerous situation occurs, based on the information generated from the precision positioning device 231 and the first cognition device 232, and a first controller 234 to control steering and a speed by calculating a required command value depending on the generated information and the determination result,

Meanwhile, the second autonomous driving controller 240 may be configured to include a second cognition device 241 to generate the information on the line and the information on the vehicle driving in front, based on the sensing information received from a front camera 212 and a front radar 211, and a second controller 242 to calculate the required command value based on the information on the line and the information on the vehicle driving in front, which are generated from the second cognition device 241 and to perform the controlling of the deceleration based on the calculated required command value. In this case, the second controller 242 may perform the controlling of the deceleration in the state that a lane is maintained (in a lane keeping state). The controlling of the deceleration may be performed until the autonomous driving vehicle is stopped.

The second autonomous driving controller 240 may be configured in minimum logic because it is unnecessary to perform a normal operating function of the autonomous driving.

The second autonomous driving controller 240 may use the line information recognized through the front camera 212 to control a vehicle lateral behavior, and may use sensing information from the front radar 211 to calculate acceleration/deceleration for preventing the collision with the front vehicle in the vehicle deceleration.

The second autonomous driving controller 240 may perform the MRM only using two pieces of sensing information.

The second autonomous driving controller 240 may calculate a required steering value for lane keeping control and a deceleration/acceleration value, which is to prevent the collision with the front vehicle, regardless of activating the autonomous driving function.

The second autonomous driving controller 240 may be equipped with logic to determine whether a driver is involved. The second autonomous driving controller 240 has to release the autonomous driving function when sensing that the driver is involved, even during MRM by obtaining the control authority due to the fault of the first autonomous driving controller 230.

The second autonomous driving controller 240 may sense a dangerous situation based on the sensing information collected from the front radar 211 and the front camera 212. The second autonomous driving controller 240 may perform control operations, such as emergency braking or a stop on the shoulder after changing a lane, when sensing the dangerous situation.

For example, the first controller 220 may perform a control operation to transmit a predetermined control signal to the warning alarm device 250 to output a predetermined warning alarm message for a request (take-over-request) for transferring the control authority from the system to the driver, when the system fault is sensed or the autonomous driving controller is automatically switched over depending on the system fault.

For another example, the second controller 260 may control the dual autonomous driving controller to perform switchover when sensing the system fault, and may transmit a predetermined control signal to the warning alarm device 250, thereby performing a control operation to output the predetermined warning alarm message for a request for transferring the control authority from the system to the driver.

When the control authority is completely transferred from the system to the driver while the warning alarm message is output, the second autonomous driving controller 240 may transmit a predetermined control signal to the warning alarm device 250 to stop outputting the warning alarm message.

According to one form, the second autonomous driving controller 240 may sense the system fault depending on the predetermined control signal received from the second controller 260.

For example, the system fault may be a controller fault occurring in the first autonomous driving controller 230. The second controller 260 may perform the controlling of a dual (or switchover) control to switch over the control authority over the autonomous driving from the first autonomous driving controller 230 to the second autonomous driving controller 240 when the fault of the first autonomous driving controller 230 occurs.

When the control authority is transferred from the system to the driver as the warning alarm message is output, the outputting of the warning alarm message may stopped, and the second autonomous driving controller 240 may release the autonomous driving.

The first controller 220 (in detail, the second autonomous driving controller 240) may perform the controlling of the deceleration in a lane keeping state until the autonomous driving vehicle is stopped, and may sense that the driver is involved during the controlling of the deceleration in the lane keeping state (for example, sense lateral control). In this case, the first controller 220 may automatically transfer the control authority from the system to the driver and release the autonomous driving.

The first controller 220 (in detail, the second autonomous driving controller 240) may enter an MRM mode to adaptively control a deceleration degree to prevent collision with a front vehicle in the lane keeping state.

The second controller 260 may include a steering controller 261 to adjust a lateral behavior (for example, lateral control) of the autonomous driving vehicle and an acceleration/deceleration controller 262 to adjust a longitudinal behavior (for example, a driving speed) of the autonomous driving vehicle.

The first autonomous driving controller 230 may be connected to the steering controller 261 and the acceleration/deceleration controller 262 through a first communication line 270, and the second autonomous driving controller 240 may be connected to the steering controller 261 and the acceleration/deceleration controller 262 through a second communication line 280.

To this end, each of the steering controller 261 and the acceleration/deceleration controller 262 may include a first communication port connected to the first communication line 270 and a second communication port connected to the second communication line 280.

The steering controller 261 and the acceleration/deceleration controller 262 may make communication with the second autonomous driving controller 240 by automatically switching over a communication line, which is in use, to the second communication line 280 from the first communication line 270, when sensing a communication fault during the use of the first communication line 270 (for example, a signal is not updated).

According to another form, the steering controller 261 and the acceleration/deceleration controller 262 may switch over a communication line, and transmit a predetermined fault sensing signal to the second autonomous driving controller 240 to activate the second autonomous driving controller 240, when sensing the system fault.

The steering controller 261 and the acceleration/deceleration controller 262 are actuator-driven controllers to perform the lateral control and the longitudinal control of the vehicle at the final stage.

Accordingly, basically, the steering controller 261 and the acceleration/deceleration controller 262 may have control logic to control the autonomous driving vehicle in response to a required command of the first autonomous driving controller 230.

In addition, each of the steering controller 261 and the acceleration/deceleration controller 262 may have logic to determine the fault of the first autonomous driving controller 230.

In this case, the reason why the steering controller 261 and the acceleration/deceleration controller 262 may have logic to determine the fault is that the first communication line 270 may cause the failure of a communication signal which is input into each of the he steering controller 261 and the acceleration/deceleration controller 262 as illustrated in FIG. 2.

The steering controller 261 and the acceleration/deceleration controller 262 regularly receive signals from the first autonomous driving controller 230 and the second autonomous driving controller 240. Accordingly, the steering controller 261 and the acceleration/deceleration controller 262 may have logic to receive a required command value for driving control from the second autonomous driving controller 240, when the fault of the first autonomous driving controller 230 is determined.

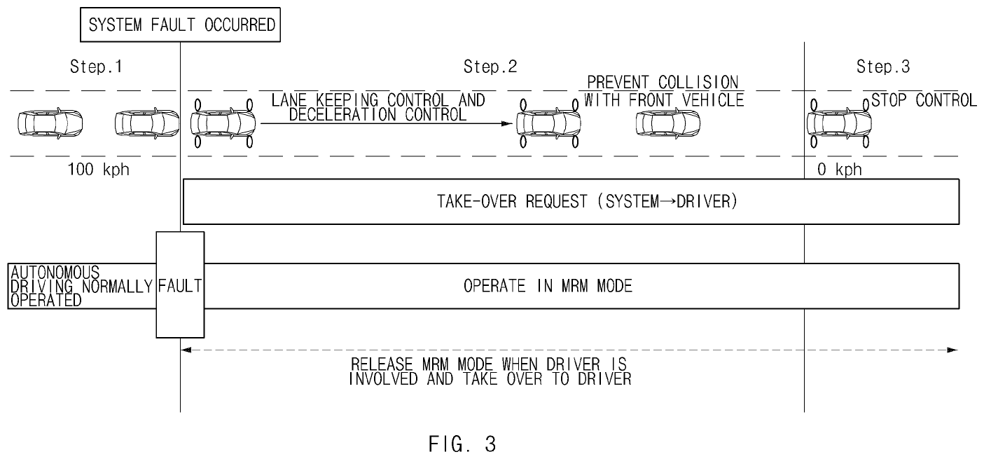

FIG. 3 is a view illustrating a procedure of controlling autonomous driving as a system fault occurs, according to another form of the present disclosure.

A driver may activate the autonomous driving by inputting a predetermined button provided in a vehicle by way of example. In addition, the driver may control an autonomous driving function through voice recognition or gesture recognition.

Referring to FIG. 3, the vehicle may drive at a constant speed of 100 km/h in a section in which the autonomous driving system is operating normally. When sensing the system fault (for example, the fault of the first autonomous driving controller 230) during the autonomous driving, the vehicle may switch over the autonomous driving controller from the first autonomous driving controller 230 to the second autonomous driving controller 240 and then enter the MRM mode.

The vehicle in the MRM mode may start controlling deceleration in the lane keeping state.

When sensing another vehicle in front during decelerating in the lane keeping state, the vehicle may adjust a deceleration degree to prevent vehicle collision.

When sensing, in the MRM mode, that a driver is involved during decelerating in the lane keeping state (for example, sensing the lateral control), the vehicle may automatically transfer the control authority from the system to the driver.

The vehicle in the MRM mode may output a predetermined warning alarm message for a request (or take-over request) for transferring the control authority from the system to the driver, until the vehicle is completely stopped through deceleration.

When the fault of the first autonomous driving controller 230 or an inter-controller communication fault occurs, the steering controller 261 to perform the lateral behavior of the vehicle and the acceleration/deceleration controller 262 to perform the longitudinal behavior of the vehicle may not receive any required command value from the first autonomous driving controller 230. Accordingly, although the deceleration is possible, but the lane keeping of the vehicle is difficult, there may occur an emergency situation of colliding with a front object.

In the control of the longitudinal behavior, a strategy of performing emergency braking may be adopted to the emergency situation to avoid a dangerous situation by way of example. According to another form of the present disclosure, in a strategy of stopping a vehicle within a lane, deceleration control may be performed instead of the emergency braking to ensure time to transfer the control authority to the driver, thereby minimizing a risk of colliding with a front vehicle while inducing the transfer of the control authority to the driver as soon as possible.

According to the MRM in the forms of the present disclosure, the vehicle may be safely stopped while decelerating.

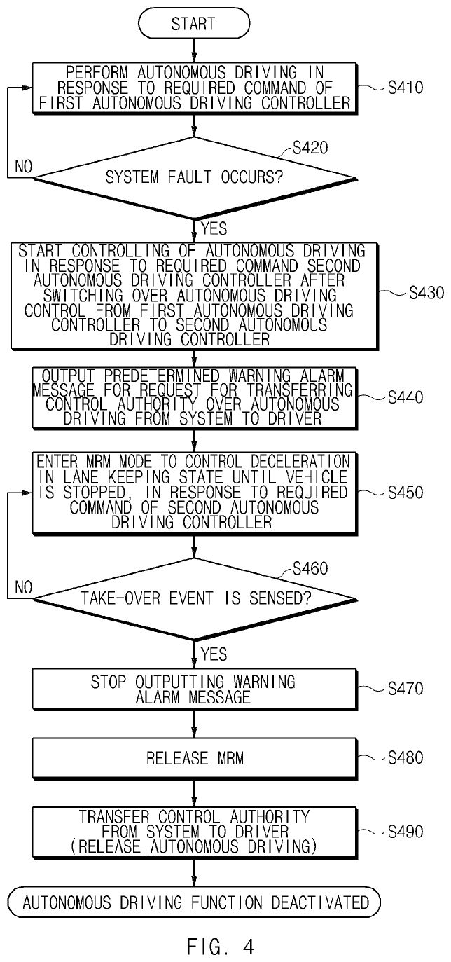

FIG. 4 is a flowchart illustrating a method for controlling autonomous driving in an apparatus for controlling autonomous driving, according to another form of the present disclosure.

Hereinafter, the apparatus 200 for controlling the autonomous driving will be simply referred to as an apparatus 200 for the convenience of explanation.

Referring to FIG. 4, the apparatus 200 may perform autonomous driving in response to a required command of the first autonomous driving controller 230, when an autonomous driving function is activated (S410).

The apparatus 200 may determine whether the system fault occurs during the controlling of the autonomous driving (S420). In this case, the system fault may include a communication fault as well as a controller fault. For example, the controller fault may include a fault of the first autonomous driving controller 230.

When the system fault occurs as the determination result, the apparatus 200 may switch over the control authority over autonomous driving from the first autonomous driving controller 230 to the second autonomous driving controller 240 and may control the driving of the vehicle in response to the required command generated in the second autonomous driving controller 240 (S430)

The apparatus 200 may output a predetermined warning alarm message for a request for transferring the control authority over autonomous driving from the system to the driver (S440).

The apparatus 200 may enter the MRM mode to control the deceleration in the lane keeping state until the vehicle is stopped, in response to the required command of the second autonomous driving controller 240 (S450).

The apparatus 200 may determine whether a take-over event occurs during the controlling of deceleration in the lane keeping state, in the MRM mode (S460).

For example, the take-over event may be sensed as the driver is involved. In this case, the driver involved may be sensed as the driver performs the lateral control.

The apparatus 200 may stop outputting the warning alarm message and may terminate the MRM mode, when sensing the take-over event (S470 to S480).

The apparatus 200 may complete transferring the control authority from the system to the driver by releasing the autonomous driving (S490).

According to one form, the second autonomous driving controller 240 may transmit a predetermined signal for releasing the autonomous driving function to the steering controller 261, the acceleration/deceleration controller 262, and the warning alarm device 250, thereby deactivating the autonomous driving function, when sensing the take-over event as the driver is involved.

The operations of the methods or algorithms described in connection with the processor forms disclosed in the present disclosure may be directly implemented with a hardware module, a software module, or the combinations thereof, executed by the processor. The software module may reside on a storage medium (that a memory and/or a storage), such as a RAM, a flash memory, a ROM, an erasable and programmable ROM (EPROM), an electrically EPROM (EEPROM), a register, a hard disc, a removable disc, or a compact disc-ROM (CD-ROM).

The exemplary storage medium may be coupled to the processor. The processor may read out information from the storage medium and may write information in the storage medium. Alternatively, the storage medium may be integrated with the processor. The processor and storage medium may reside in an application specific integrated circuit (ASIC). The ASIC may reside in a user terminal. Alternatively, the processor and the storage medium may reside as separate components of the terminal of the user.

The present disclosure provides a method and an apparatus for controlling autonomous driving.

In addition, the present disclosure provides a method for controlling autonomous driving, capable of providing MRM in a dangerous situation during the autonomous driving, and an apparatus for the same.

Further, the present disclosure provides a method for controlling autonomous driving, capable of minimizing a risk resulting from the fault of an autonomous driving system through dual autonomous driving controllers, and an apparatus for the same.

Further, the present disclosure provides a method for controlling autonomous driving, capable of performing MRM by automatically transferring a control authority over a system to a second autonomous driving controller in the fault of a first autonomous driving controller, and an apparatus for the same.

In addition, the present disclosure provides an autonomous driving system which is more safe and convenient.

Besides, a variety of effects directly or indirectly understood through the disclosure may be provided.

Hereinabove, although the present disclosure has been described with reference to exemplary forms and the accompanying drawings, the present disclosure is not limited thereto, but may be variously modified and altered by those skilled in the art to which the present disclosure pertains without departing from the spirit and scope of the present disclosure.

Therefore, the exemplary forms of the present disclosure are provided to explain the spirit and scope of the present disclosure, but not to limit them, so that the spirit and scope of the present disclosure is not limited by the forms.

What is claimed is:

1. A method for controlling autonomous driving of an autonomous driving vehicle including a first autonomous driving controller and a second autonomous driving controller which are provided in a dual structure, the method comprising:
monitoring, by the first autonomous driving controller, a system fault during the autonomous driving;
when the system fault is detected, switching over to the second autonomous driving controller; and
entering, by the second autonomous driving controller, a Minimum Risk Management (MRM) mode to control deceleration of the autonomous driving vehicle.

2. The method of claim 1, wherein the system fault includes:
at least one of a fault of a controller to control a behavior of the autonomous driving vehicle or a communication fault.

3. The method of claim 2, wherein the second autonomous driving controller partially includes a function of the first autonomous driving controller.

4. The method of claim 3, wherein the fault of the controller is a fault of the first autonomous driving controller, and
wherein when the fault of the first autonomous driving controller occurs, a control authority over the autonomous driving is transferred to the second autonomous driving controller.

5. The method of claim 3, wherein the first autonomous driving controller includes:
a precision positioning equipment, a cognition equipment, a determination equipment, and a control equipment, based on sensing information, and
wherein the second autonomous driving controller includes:
the cognition equipment to recognize a line and a vehicle driving in front, based on the sensing information from a front camera and a front radar; and
the control equipment to control the deceleration of the autonomous driving vehicle by calculating a required command value based on the recognized line and vehicle driving in front.

6. The method of claim 3, wherein the autonomous driving vehicle includes:
a steering controller configured to adjust a driving direction of the autonomous driving vehicle;
an acceleration/deceleration controller configured to adjust a driving speed of the autonomous driving vehicle;
a first communication line configured to connect the first autonomous driving controller, the steering controller, and the acceleration/deceleration controller together; and
a second communication line configured to connect the second autonomous driving controller, the steering controller, and the acceleration/deceleration controller together, and
wherein the first communication line is automatically switched over to the second communication line for use when the communication fault is sensed while the first communication line is used.

7. The method of claim 6, wherein the steering controller and the acceleration/deceleration controller transmit a predetermined fault sensing signal to the second autonomous driving controller to activate the second autonomous driving controller, when sensing the system fault.

8. The method of claim 1, further comprising:
outputting a predetermined warning alarm message for a request for transferring a control authority from a system to a driver of the autonomous driving vehicle, when sensing the system fault,
wherein the outputting of the predetermined warning alarm message is stopped and the autonomous driving is released, when the control authority is completely transferred.

9. The method of claim 1, wherein the controlling of the deceleration is performed in a state that a lane is maintained, until the autonomous driving vehicle is stopped, and
wherein a control authority is automatically transferred from a system to a driver such that the autonomous driving is released, when sensing that the driver is involved during the controlling of the deceleration.

10. The method of claim 9, wherein a deceleration degree is adaptively controlled in the state that the lane is maintained, to prevent collision with a front vehicle.

11. An apparatus for controlling autonomous driving, the apparatus comprising:
a sensor mounted on an inner portion or an outer portion of an autonomous driving vehicle and configured to generate sensing information;
a first controller including a first autonomous driving controller and a second autonomous driving controller, which are provided in a dual structure and configured to control autonomous driving based on the sensing information received from the sensor; and
a second controller configured to sense a system fault during the autonomous driving by using the first autonomous driving controller,
wherein when the system fault is detected, the first controller is configured to switch over to the second autonomous driving controller, and enter a Minimum Risk Management (MRM) mode to control deceleration of the autonomous driving vehicle.

12. The apparatus of claim 11, wherein the system fault includes:
at least one of a fault of a controller of the autonomous driving vehicle or a communication fault.

13. The apparatus of claim 12, wherein the second autonomous driving controller is configured to partially perform a function of the first autonomous driving controller.

14. The apparatus of claim 13, wherein the fault of the controller is a fault of the first autonomous driving controller, and
wherein when the fault of the first autonomous driving controller occurs, the second controller is configured to perform a control operation to switch over a control authority over the autonomous driving to the second autonomous driving controller.

15. The apparatus of claim 13, wherein the first autonomous driving controller includes:
a precision positioning device configured to generate information on a present position of the autonomous driving vehicle, based on the sensing information;
a first cognition device configured to generate information on a line and information on a vehicle driving in front, based on the sensing information;
a determination device configured to determine whether a dangerous situation occurs, based on the generated information;
a first controller configured to control steering and a speed of the autonomous driving vehicle by calculating a required command value based on the generated information and the determination result,
wherein the sensor includes a front camera and a front radar, and
wherein the second autonomous driving controller includes:
a second cognition device configured to generate the information on the line and the information on the vehicle driving in front, based on the sensing information received from the front camera and the front radar; and
a second controller configured to control the deceleration of the autonomous driving vehicle by calculating the required command value based on the information on the line and the information on the vehicle driving in front.

16. The apparatus of claim 13, wherein the second controller includes:
a steering controller configured to adjust a driving direction of the autonomous driving vehicle; and
an acceleration/deceleration controller configured to adjust a driving speed of the autonomous driving vehicle,
wherein the autonomous driving vehicle includes:
a first communication line configured to connect the first autonomous driving controller, the steering controller, and the acceleration/deceleration controller together; and
a second communication line configured to connect the second autonomous driving controller, the steering controller, and the acceleration/deceleration controller together, and
wherein the first communication line is automatically switched over to the second communication line for use when the communication fault is sensed while the first communication line is used.

17. The apparatus of claim 16, wherein the steering controller and the acceleration/deceleration controller are configured to transmit a predetermined fault sensing signal to the second autonomous driving controller to activate the second autonomous driving controller, and receive a required command from the second autonomous driving controller, when the system fault is detected.

18. The apparatus of claim 11, further comprising:
a warning alarm device configured to output a predetermined warning alarm message for a request for transferring a control authority from a system to a driver of the autonomous driving vehicle,
wherein when the control is completely transferred, the outputting of the warning alarm message is stopped and the autonomous driving is released.

19. The apparatus of claim 11, wherein the first controller is configured to:
control the deceleration of the autonomous driving vehicle, while maintaining a lane on which the autonomous driving vehicle travels until the autonomous driving vehicle is stopped, and
when the driver intervenes in the deceleration, automatically transfer a control authority from a system to the driver of the autonomous driving vehicle such that the autonomous driving is released,.

20. The apparatus of claim 19, wherein the first controller is configured to adaptively control a deceleration degree in the state the lane is maintained, to prevent collision with a front vehicle.
